(19) United States
(12) Patent Application Publication
(10) Pub. No.: US 2007/0128463 A1
(43) Pub. Date: Jun. 7, 2007

(54) MULTI-ALLOY MONOLITHIC EXTRUDED STRUCTURAL MEMBER AND METHOD OF PRODUCING THEREOF

(76) Inventors: Gwendolyn Dixon, Murrysville, PA (US); Robert C. Pahl, W. Lafayette, IN (US); Michael Kulak, Murrysville, PA (US); Markus B. Heinimann, New Alexandria, PA (US); Brandon H. Bodily, Everett, WA (US)

Correspondence Address: Harry A. Hild, Jr.;Alcoa Technical Center, Intellectual Property, Building C, 100 Technical Drive, Alcoa Center, PA, 15069-0001, US

(21) Appl. No.: 11/558,265

(22) Filed: Nov. 9, 2006

Related U.S. Application Data
(60) Provisional application No. 60/734,913, filed on Nov. 9, 2005.

(51) Int. Cl. C22F 1/04; B32B 15/20

(52) U.S. Cl. 428/654; 148/535; 148/689

(57) ABSTRACT

The present invention provides a structural member of a multi-alloy monolithic extrusion comprising a first aluminum alloy and a second aluminum alloy; wherein the first aluminum alloy is metallurgically fused to the second aluminum alloy. In another aspect of the present invention, an extrusion method is provided including the steps of providing a first billet and at least a second billet; machining the first billet to form a first substantially flat surface; machining the second billet to form a second flat surface; positioning the first flat surface of the first billet adjacent to the second flat surface of the second billet; welding at least a portion of the first billet to the second billet to form a third billet; and extruding the third billet to form a monolithic multi-alloy structural member.

### CROSS REFERENCE TO RELATED APPLICATION

The present invention claims the benefit of U.S. provisional patent application 60/734,913 filed Nov. 9, 2005 the entire contents and disclosure of which is incorporated by reference as is fully set forth herein.

### FIELD OF THE INVENTION

This invention pertains to aluminum extruded structural members. More particularly, this invention pertains to an aluminum multi-alloy monolithic extruded aircraft or vehicular structural member.

### BACKGROUND OF THE INVENTION

There are numerous applications that require a monolithic structural member to satisfy two dichotomous design requirements. In aerospace applications for example, engine beams, wing spars, and horizontal stabilizer spars have material requirements that differ in specific part locations. Material placement in these parts is currently accomplished by fastening skins and stingers in the wing and fuselage and attaching 2XXX and 7XXX series aluminum alloy spar caps in spars to achieve optimum load carrying capabilities. The 2XXX series aluminum alloy increases the part's damage tolerance while the 7XXX series aluminum alloy increases the part's structural and mechanical strength. Although this traditional “built-up” design is weight effective, it can be very costly to produce.

Other aerospace structural members such as fuselage stringers and top center wing boxes can also benefit from a high performance/weldable alloy combination. The key is having the weldable alloy near the joint. Extrusions with this type of combination enables alloys with good performance but poor weldability to be used for a wider range of structural applications that also require good weldability.

In light of the above, a need exists for a multi-alloy monolithic extruded structural member that can satisfy two dichotomous design requirements while reducing overall manufacturing time and costs associated with manufacturing such a vehicular structural member.

### SUMMARY OF THE INVENTION

The present invention discloses a multi-alloy monolithic extruded structural member. The multi-alloy monolithic extruded vehicular structural member includes a first aluminum alloy and a second aluminum alloy.

In one embodiment, the first aluminum alloy and/or the second aluminum alloy is a heat treatable or a non-heat treatable aluminum alloy. In another embodiment, the first aluminum alloy and/or the second aluminum alloy is an aluminum-lithium alloy.

In yet another embodiment, the first aluminum alloy and/or the second aluminum alloy is an Aluminum Association 2XXX, 6XXX or 7XXX series aluminum alloy.

In another embodiment, a first alloy is selected for strength performance, and at least a second alloy selected for toughness, fatigue, and weldability performance depending upon the performance requirements of the extrusion.

This invention also discloses a method for manufacturing the multi-alloy monolithic extruded structural member. The method includes providing a first billet and at least a second billet each having an exterior surface, first end, and a second end; machining the first billet to form a first substantially flat surface; machining the second billet to form a second flat surface, positioning the first flat surface of the first billet adjacent to the second flat surface of the second billet, welding at least a portion of the first billet to the second billet to form a third billet, and extruding the third billet to form the monolithic multi-alloy structural member.

Another aspect of the present invention is to provide an extruded vehicular structural member suitable for aerospace applications having improved fracture toughness and resistance to fatigue crack growth.

Another aspect of the present invention is to provide an extruded vehicular structural member that exhibits improved fracture toughness, bearing strength, compression strength, tensile strength, and increased resistance to fatigue crack growth and corrosion.

Another aspect of this invention is to provide an aircraft structural member that can be meet the dichotomous strength and damage tolerance requirements typically found in the aerospace industry yet be light weight.

Another aspect of this invention is to provide an aircraft or vehicular structural member that can reduce the costs associated with manufacturing “traditional” aircraft or vehicular structural members.

These and other aspects will become apparent from a reading of the specification and claims and an inspection of the claims appended hereto.

### BRIEF DESCRIPTION OF THE DRAWINGS

FIG. 1. pictorially represents the longitudinal (L), long transverse (LT), and short transverse (ST) directions of an extrusion.

FIG. 2 depicts a plot of micro-hardness across the cross-section of a multi-alloy monolithic extrusion composed of an Aluminum Association 2XXX series alloy and an Aluminum Association 7XXX series alloy, in accordance with the present invention.

FIGS. 3a-3d depicts four (4) shapes that may be provided in a multi-alloy monolithic extrusion configuration, formed in accordance with the present invention.

FIG. 4 depicts one embodiment of a multi-alloy integral stiffened panel, formed in accordance with the present invention.

FIGS. 5a and 5b depict one embodiment of a multi-alloy monolithic extrusion including portions having an alloy selected for welding performance.

FIG. 6 depicts one embodiment of a multi-alloy monolithic extrusion having attachment flanges composed of an alloy providing improved crack growth properties.

FIG. 7 depicts one embodiment of a multi-alloy monolithic extrusion of a rocker arm composed of alloys selected for strength, durability and wear characteristics.

FIG. 8 depicts one embodiment of a multi-alloy monolithic extrusion of a fuselage frame composed of alloys to provide high strength and improved fatigue performance.

FIG. 9 depicts one embodiment of a high strength stiffener formed as a multi-alloy monolithic extrusion composed of an alloy selected to provide improved toughness performance.

FIG. 10 depicts one embodiment of a stringer formed as a multi-alloy monolithic extrusion, in accordance with the present invention, wherein alloys are selected for strength and toughness (fatigue resistance) performance.

FIGS. 11a (cross sectional view) and 11b (side view) depict one embodiment of a multi-alloy monolithic extrusion in which an alloy having improved fatigue resistance functions as crack stopper between portions of the multi-alloy monolithic extrusion having high strength.

FIGS. 12a and 12b depict side views of embodiments of the placement of sectioned billets prior to co-extrusion, in accordance with the present invention.

FIG. 13 is a graph depicting the ultimate tensile strength of one embodiment of a multi-alloy monolithic extrusion composed of Aluminum Association 2024 and 7075, formed in accordance with the present invention, and comparative examples of extrusions of Aluminum Association 2024 and 7075.

FIG. 14 depicts a micrograph of a failure observed in one embodiment of a 2024/7075 multi-alloy monolithic extrusions aged to T73 temper.

FIG. 15 is a graph depicting the tensile yield strength of one embodiment of a multi-alloy monolithic extrusion composed of Aluminum Association 2024 and 7055, formed in accordance with the present invention, measured along the longitudinal (L) direction, and comparative examples of extrusions of Aluminum Association 2024, 7075,

FIG. 16 is a graph depicting the percent elongation of one embodiment of a multi-alloy monolithic extrusion composed of Aluminum Association 2024 and 7055, formed in accordance with the present invention, measured along the long transverse (LT) direction and comparative examples of extrusions of Aluminum Association 2024 and 7075.

FIG. 17 is a graph depicting the tensile yield strength of one embodiment of a multi-alloy monolithic extrusion composed of Aluminum Association 7475 and 7055, formed in accordance with the present invention, and comparative examples of extrusions of Aluminum Association 7475 and 7055.

FIG. 18 is a graph depicting the compression yield strength of one embodiment of a multi-alloy monolithic extrusion composed of Aluminum Association 7475 and 7055, formed in accordance with the present invention, measured along the short transverse (ST) direction, and comparative examples of extrusions of Aluminum Association 7475 and 7055.

### DETAILED DESCRIPTION OF PREFERRED EMBODIMENTS

The accompanying figures and the description that follows set forth this invention in its preferred embodiments. However, it is contemplated that persons generally familiar with aluminum alloy extrusions will be able to apply the novel characteristics of the structures and methods illustrated and described herein in other contexts by modification of certain details. Accordingly, the figures and the description are not to be taken as restrictive on the scope of this invention, but are to be understood as broad and general teachings. When referring to any numerical range of values, such ranges are understood to include each and every number and/or fraction between the stated range minimum and maximum. As used herein, the term “incidental impurities” refers to elements that are not purposeful additions to the alloy, but that due to impurities and/or leaching from contact with manufacturing equipment, trace quantities of such elements being no greater than 0.05 wt. % may, nevertheless, find their way into the final alloy product. Finally, for purposes of the description hereinafter, the terms “upper”, “lower”, “right”, “left”, “vertical”, “horizontal”, “top”, “bottom”, and derivatives thereof shall relate to the invention, as it is oriented in the drawing figures.

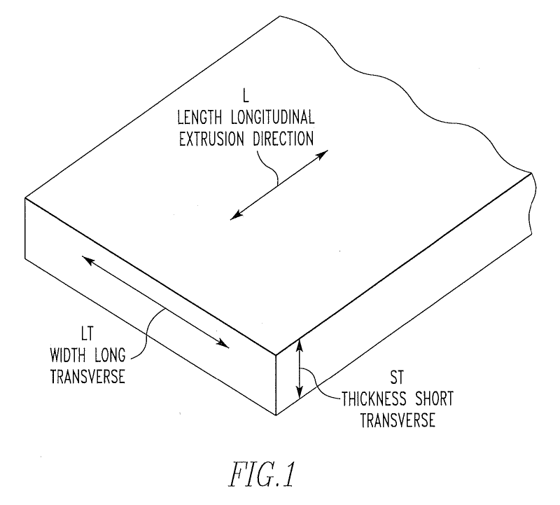

The present invention discloses an aluminum multi-alloy monolithic extruded aircraft or vehicular structural member (structural member) having at least a first aluminum alloy and a second aluminum alloy. Preferably, the first and second alloy are selected to meet the performance requirements of the structure, wherein the alloy composition may be selected to provide improved fatigue toughness, bearing strength, compression strength, tensile strength, increased resistance to fatigue crack growth, corrosion and weld-ability performance. For the purposes of this disclosure, the term “multi-alloy monolithic extrusion” denotes a unitary structure composed of at least two metal alloys having a dimensionally constant cross section along the longitudinal direction of the structure, wherein the mechanical performance of the multi-alloy unitary structure, acts as a single, rigid, uniform whole. FIG. 1 depicts the longitudinal (L), long transverse (LT), and short transverse (ST) directions of an extrusion. The longitudinal (L) direction is parallel to the extrusion direction, the long transverse (LT) represents the width of the extrusion, and the short transverse direction (ST) represents the height of the extrusion.

The monolithic structural member is formed by a metallurgical fusion of the first aluminum alloy to the second aluminum alloy through an extrusion process thereby producing a structural member that is light, cost effective, and that can satisfy various strength and damage tolerance requirements. The term “metallurgical fusion” is defined as a bond formed between two metals that when mechanically tested can be characterized as having a gradual change in mechanical properties in response to an applied force across the cross-section of the structure from the first alloy to the second alloy. The mechanical testing may include peel testing, shear testing or any testing methods measuring the performance at the interface between the first and second alloy. A gradual change in mechanical properties is defined as mechanical property variation in response to an applied stress that is observed in articles having a unitary structure being free of multi-component interfaces.

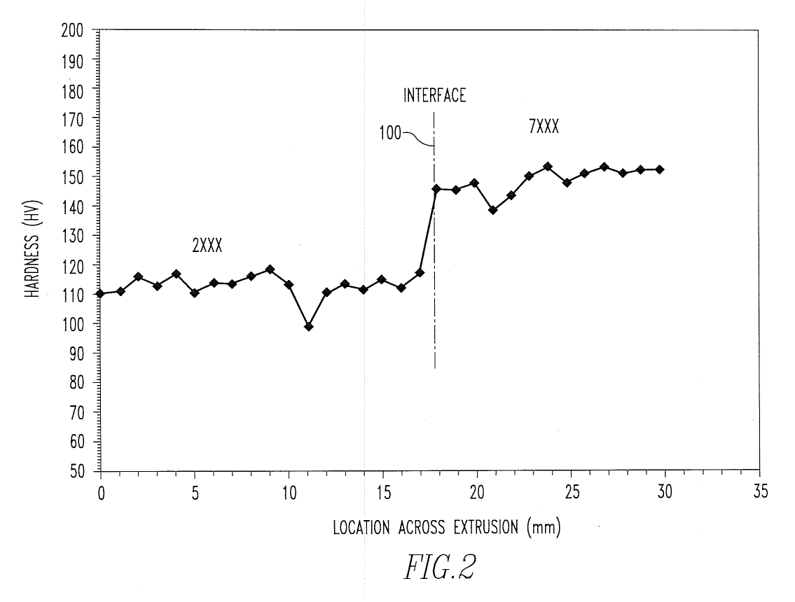

FIG. 2 depicts a graphical representation of the hardness properties across the cross section of a multi-alloy monolithic extrusion composed of Aluminum Association 2024 and 7075 alloys and heat treated to a T73 temper, in accordance with one embodiment of the present invention. As depicted in FIG. 2, the interface 100 between the Aluminum Association 2XXX alloy portion and the Aluminum Association 7XXX alloy portion of the multi-alloy monolithic extrusion has a micro hardness equal to the 7XXX alloy, hence providing a gradual change in micro-hardness (mechanical property variation in response to an applied stress) across the interface from the first alloy to the second alloy, wherein the gradual change in mechanical properties at the interface of the 7XXX and 2XXX alloys is consistent with a metallic fusion of the two alloys. Contrary to the multi-alloy monolithic extrusion of the present invention, a structure that is joined by prior methods would typically result in failure or the formation of intermetallics at the interface between the two alloys. A failure or intermetallic at the interface typically results in a measurable decrease in mechanical properties at the interface when compared to the mechanical properties of the alloy compositions that are joined at the interface.

In one embodiment, an Aluminum Association 7XXX series aluminum alloy in combination with an aluminum-lithium (Al—Li) alloy is a feasible combination for a wing box. Furthermore, an Aluminum Association 7XXX series aluminum alloy in combination with an Aluminum Association 6XXX series aluminum alloy is a feasible combination for a fuselage stringer. Additional multi-alloy combinations such as strength/durability and wear, low performance/high performance, and low cost/high cost can be tailored so that the extruded vehicular structural member is optimized with the best aluminum alloy that meets the design requirements and placed within the extrusion where it is needed thereby allowing a single vehicular structural member to satisfy dissimilar requirements simultaneously.

Accordingly, it is understood that the aluminum alloys used in the monolithic extruded vehicular structural member can be selected from the same alloy family, but have different property characteristics and therefore be considered distinct aluminum alloys.

In one embodiment, the first aluminum alloy and/or the second aluminum alloy is manufactured from heat treatable or non heat treatable aluminum alloys. Heat-treatable aluminum alloys are those that can be strengthened by a controlled cycle of heating and cooling. Some examples of heat treatable alloys include Aluminum Association 2XXX, 6XXX, and 7XXX series of aluminum alloys. Heat treatable aluminum alloys may provide increased strength by precipitate hardening mechanisms. A precipitate hardening composition may be an aluminum alloy whose strength characteristics may be enhanced by the formation of uniformly dispersed particles (precipitates) of a second phase within the original phase matrix, wherein the precipitates are formed using heat treatments. Non-heat treatable alloys depend on work hardening through mechanical reduction in conjunction with various annealing procedures for property development. Strength for non-heat treatable alloys such as 5XXX series is obtained by the hardening effect of the alloying elements. Additional strengthening is achieved by cold working.

In another embodiment, the first aluminum alloy and/or the second aluminum alloy is manufactured from an aluminum-lithium alloy. In one embodiment, an aluminum lithium alloy may include on the order of about 0.7 wt. % to about 2.0 wt. % Li. Preferred aluminum-lithium alloys include Aluminum Association 2099 and 2199.

Preferably, Aluminum Association 2099 is composed of less than 0.05 wt. % Si, less than 0.07 wt. % Fe, from about 2.4 wt. % to about 3.0 wt. % Cu, from about 0.10 wt. % to about 0.50 wt. % Mn, from about 0.10 wt. % to about 0.50 wt. % Mg, from about 0.40 wt. % to about 1.0 wt. % Zn, less than 0.1 wt. % Ti, from about 1.6 wt. % to about 2.0 wt. % Li, from about 0.05 wt. % to about 0.12 wt % Zr, and a balance of Al and incidental impurities. Preferably, Aluminum Association 2199 is composed of less than 0.05 wt. % Si, less than 0.07 wt. % Fe, from about 2.3 wt. % to about 2.9 wt. % Cu, from about 0.10 wt. % to about 0.50 wt. % Mn, from about 0.05 wt. % to about 0.40 wt. % Mg, from about 0.20 wt. % to about 0.9 wt. % Zn, less than 0.1 wt. % Ti, from about 0.7 wt. % to about 1.3 wt. % Li, from about 0.20 wt. % to about 0.7 wt % Ag, and a balance of Al and incidental impurities. In some preferred embodiments, Aluminum Association 2099 is utilized for high strength applications and Aluminum Association 2199 is utilized applications requiring in high damage tolerance

In yet another embodiment, the first aluminum alloy and/or the second aluminum alloys is manufactured from the Aluminum Association's 2XXX, 6XXX or 7XXX series of aluminum alloys. The principal alloying element in Aluminum Association 2XXX aluminum alloy is Cu. The principal alloying element in Aluminum Association 6XXX aluminum alloy is Si. The principal alloying element in Aluminum Association 7XXX aluminum alloy is Zn.

In yet another embodiment, the first aluminum alloy and/or the second aluminum alloy is manufactured from the Aluminum Association's 2×24, 2×26, 7×50, 7×55, 7×75, and 7×85 aluminum alloys. The principal alloying elements in Aluminum Association 2×24 aluminum alloy include Cu, preferably is an amount ranging from about 3.7 wt. % to about 4.9 wt. %; Mn, preferably in an amount ranging from about 0.15-0.9 wt. %; and Mg, preferably being about 1.2 wt. % to about 1.8 wt. %. The principal alloying elements in Aluminum Association 2×26 include Cu, preferably in an amount ranging from about 3.6 wt. % to about 4.3 wt. %; Mn preferably in an amount ranging from about 0.3-0.8 wt. %; and Mg, preferably being about 1.0 wt. % to about 1.6 wt. %.

The principal alloying elements in Aluminum Association 7×50 aluminum alloy preferably includes Zn, preferably in an amount ranging from about 5.7 wt. % to about 6.9 wt. %; Cu, preferably in an amount ranging from about 1.7 wt. % to 2.6 wt. %; and Mg, preferably in an amount ranging from about 1.9 wt. % to about 2.6 wt. %. The principal alloying elements in Aluminum Association 7×55 aluminum alloy preferably includes Zn, preferably in an amount ranging from about 7.6 wt. % to about 8.4 wt. %; Cu, preferably in an amount ranging from about 2.0 wt. % to 2.6 wt. %; and Mg, preferably in an amount ranging from about 2.1 wt. % to about 2.9 wt. %. The principal alloying elements in Aluminum Association 7×75 preferably includes Zn, preferably in an amount ranging from about 5.1 wt. % to about 6.1 wt. %; Cu, preferably in an amount ranging from about 1.2 wt. % to 2.0 wt. %; Mg, preferably in an amount ranging from about 2.1 wt. % to about 2.9 wt. %; and Cr, preferably in an amount ranging from about 0.18 wt. % to about 0.28 wt. %. The principal alloying elements in Aluminum Association 7×85 preferably includes Zn, preferably in an amount ranging from about 7.0 wt. % to about 8.0 wt. %; Cu, preferably in an amount ranging from about 1.3 wt. % to 2.0 wt. %; and Mg, preferably in an amount ranging from about 1.2 wt. % to about 2.8 wt. %.

Aluminum Association 6XXX aluminum alloy include, but are not limited to, Aluminum Association 6061, 6063, and 6013, and in some preferred applications are utilized to provide welding performance. Aluminum Association 6061 preferably includes about 0.4 wt. % to about 0.8 wt. % Si, less than 0.7 wt. % Fe, from about 0.15 wt. % to about 0.40 wt. % Cu, less than 0.15 wt. % Mn, from about 0.8 wt. % to about 1.2 wt. % Mg, from about 0.040 wt. % to about 0.35 wt. % Cr, less than 0.25 wt. % Zn, less than 0.15 wt. % Ti, and a balance of Al and incidental impurities. Aluminum Association 6063 preferably includes about 0.2 wt. % to about 0.6 wt. % Si, less than 0.35 wt. % Fe, less than about 0.10 wt. % Cu, less than 0.10 wt. % Mn, from about 0.45 wt. % to about 0.9 wt. % Mg, less than about 0.10 wt. % Cr, less than 0.10 wt. % Zn, less than 0.10 wt. % Ti, and a balance of Al and incidental impurities. Aluminum Association 6013 preferably includes from about 0.6 wt. % to about 1.0 wt. % Si, less than 0.50 wt. % Fe, from about 0.60 wt. % to about 1.1 wt. % Cu, from about 0.20 wt. % to about 0.80 wt. % Mn, from about 0.8 wt. % to about 1.2 wt. % Mg, less than about 0.10 wt. % Cr, less than 0.25 wt. % Zn, less than 0.10 wt. % Ti, and a balance of Al and incidental impurities.

In yet another embodiment, the first aluminum alloy is manufactured from the Aluminum Association's 7075 or 7475 aluminum alloy, while the second aluminum alloy is manufactured from the Aluminum Association's 2024 and 7055 aluminum alloy. Aluminum Association 7075 is an aluminum alloy, preferably including less than 0.12 wt. % Si, less than 0.15 wt. % Fe, from about 2.0 wt. % to about 2.6 wt. % Cu, less than 0.10 wt. % Mn, from about 1.9 wt. % to about 2.6 wt. % Mg; less than 0.04 wt. % Cr, from about 5.7 wt. % to about 6.7 wt. % Zn, less than 0.06 wt. % Ti, from about 0.08 to about 0.15 wt. % Zr, and a balance of Al and incidental impurities. Aluminum Association 7475 is an aluminum alloy preferably including less than 0.10 wt. % Si, less than 0.12 wt. % Fe, from about 1.2 wt. % to about 1.9 wt. % Cu, less than 0.06 wt. % Mn, from about 1.9 to about 2.6 wt. % Mg, from about 0.18 wt. % to about 0.25 wt. % Cr, from about 5.2 wt. % to about 6.2 wt. % Zn, less than 0.06 wt % Ti, and a balance of Al and incidental impurities. Aluminum Association 2024 is an aluminum alloy preferably including less than 0.5 wt. % Si, less than 0.5 wt. % Fe, from about 3.8 wt. % to about 4.9 wt. % Cu, from than 0.30 wt. % to about 0.9 wt. % Mn, from about 1.2 wt. % to about 1.8 wt. % Mg, less than 0.10 wt. % Cr, less than 0.25 wt. %, less than 0.15 wt. % Ti, and a balance of Al and incidental impurities.

In another embodiment of the present invention, the multi-alloy monolithic extrusion may be composed of at least two alloys selected from a single alloy family. For example the multi-alloy monolithic extrusion may be composed of two or more alloys within the Aluminum Association 7XXX series alloys, such as Aluminum Association 7055, 7075, or 7475; or two or more alloys within the Aluminum Association 6XXX series alloys, such as Aluminum Association 6061, 6063, or 6013; or two or more alloys within Aluminum Association 2XXX series alloys, such as Aluminum Association 2199, 2024, and 2099.

One advantage of multi-alloy monolithic extrusion composed of alloys from same Aluminum Association series (alloys having similar alloying constituents) is that the entire multi-alloy monolithic extrusion may be heat treated to substantially peak performance, since aluminum alloys having similar alloying constituents and concentrations typically benefit from similar heat treatments. In some instances, multi-alloy monolithic extrusions of alloys of differing alloying constituents and concentrations may result in different heat treatment requirements and may result in a multi-alloy monolithic extrusion in which one portion of the extrusion is not heat treated to optimum specifications.

In one embodiment, the alloy compositions within the family may be selected to provide strength or fatigue/toughness performance. Typically, strength and fatigue/toughness performance are inversely proportional, wherein an alloy having a very high strength may have lower ductility, toughness, and fatigue performance when compared to a lower strength alloy. This scenario is observable in 2XXX and 7XXX series alloys, wherein 2XXX alloys may provide toughness and fatigue performance and 7XXX alloys may provide strength. For example, in precipitate hardening compositions a high degree of strengthening precipitates can provide increased strength, but typically results in decreased ductility, toughness and fatigue performance.

The aluminum multi-alloy monolithic extruded aircraft or vehicular structural member disclosed in this invention can be aircraft structural member such as an aircraft engine beam, a landing gear beam, a wing spar, a horizontal stabilizer spar, a fuselage stringer, a top center wing box, or an extruded machined rib. In another embodiment, the aluminum multi-alloy monolithic extruded aircraft or vehicular structural member disclosed in this invention is a component for use in an automobile, motorcycle, bicycle, scooter, truck, bus, ship, submarine, tractor, or train.

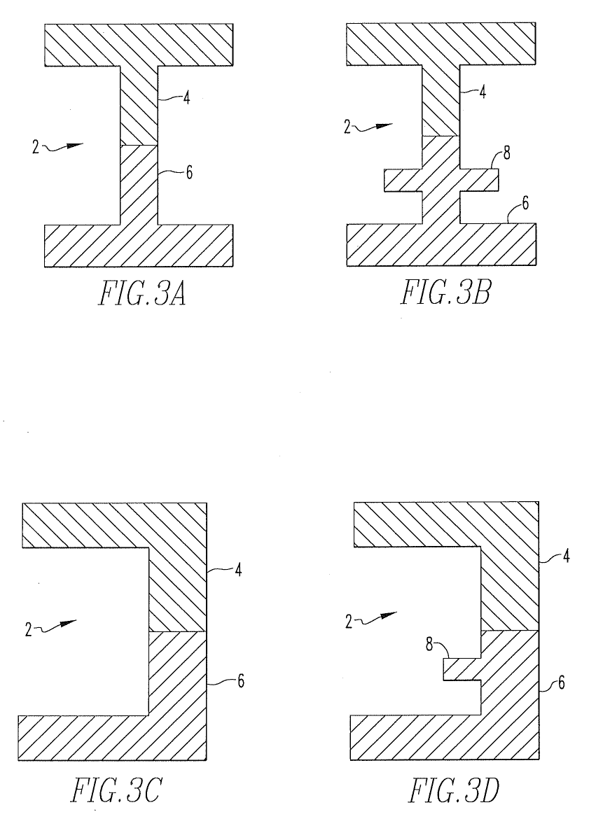

FIGS. 3(a)-3(d) depict four shapes that may be formed as a multi-alloy monolithic extrusion, in accordance with the present invention. FIGS. 3(a)-3(d) depict one embodiment of a wing spar 2 composed of a first aluminum alloy 4 and a second aluminum alloy 6. The first aluminum alloy 4 could be selected from the heat treatable aluminum alloy compositions, non-heat treatable aluminum alloy compositions, and aluminum alloy compositions including lithium. The second aluminum alloy 6 could also be selected from heat treatable aluminum alloy compositions, non-heat treatable aluminum alloy compositions, and aluminum alloy compositions including lithium.

FIGS. 3(b) and 3(d) depicts one embodiment of a multi-alloy monolithic extrusion configured to provide wing spar 2 including a crack arrest feature 8. In one embodiment, the first aluminum alloy 4 and/or second aluminum alloy 6 can selected from the Aluminum Association's 2XXX, or 7XXX series of aluminum alloys. The selection of the alloys and their positioning in the multi-alloy monolithic extrusion may be determined by the mechanical performance required of the structure.

For example, in one embodiment portions of the structure requiring toughness and fatigue resistance performance, such as the crack arrest feature, may utilize an aluminum alloy within the family of Aluminum Association 2XXX series alloys, such as Aluminum Association 2199, 2024, and 2099, and portions of the structure requiring high strength may utilize an aluminum alloy within the family of Aluminum Association 7XXX series alloys, such as Aluminum Association 7×50, 7×55, 7×75, 7×85, preferably being Aluminum Association 7055, 7075 or 7475. In another embodiment, the first or second aluminum alloy 4, 6 could be an Aluminum Lithium (Al—Li) aluminum alloy. In another example, multi-alloy monolithic extrusion wing spar 2 may be composed of aluminum alloy of the same Aluminum Association series, whereas portions requiring high strength would have a higher degree of precipitate hardening constituents than portions of the structure requiring fatigue and toughness performance.

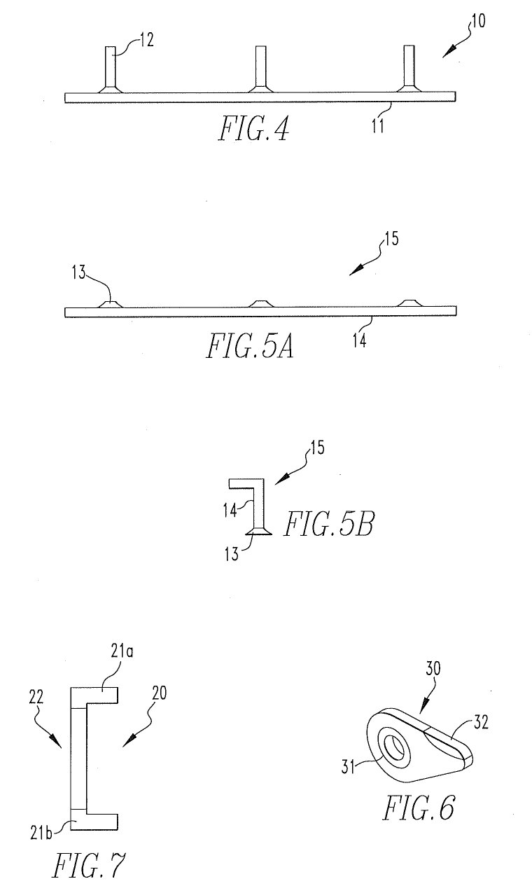

FIG. 4 depicts one embodiment of a multi-alloy monolithic extrusion configured to provide an integral stiffened panel 10. In one embodiment, the surface 11 of the integral stiffened panel 10 is composed of an alloy for high toughness and fatigue resistance, such as an Aluminum Association 2XXX series alloy, and the support structures 12 may be composed of a high strength alloy, such as an Aluminum Association 7XXX series alloy. In some preferred embodiments, Aluminum Association 2099 is utilized for high strength applications and Aluminum Association 2199 is utilized applications requiring in high damage tolerance. In another example, multi-alloy monolithic extrusion integral stiffened panel 10 may be composed of aluminum alloy of the same Aluminum Association series, whereas portions requiring high strength would have a higher degree of precipitate hardening constituents than portions of the structure requiring fatigue and toughness performance.

FIGS. 5a and 5b depict a welding structure 15 formed from a multi-alloy monolithic extrusion that is configured to provide a means for welded attachment of another structure member, wherein the means for a welded attachment is provided by weldable pads 13 of a weldable alloy metallurgically fused to a base structure 14. The weldable pads 13 may be formed of a 6XXX aluminum alloy, such as 6013, 6063, or 6061, or a 7XXX alloy similar to Aluminum Association 7005. Aluminum Association 7005 typically includes less than 0.35 wt. % Si, less than 0.4 wt. % Fe, less than 0.10 wt. % Cu, from about 0.20 to about 0.7 wt % Mn, from about 1.0 wt % to about 1.8 wt % Mg, from about 0.06 wt. % to about 0.20 wt %. Cr, from about 4.0 wt. % to about 5.0 wt. % Zn, less than 0.06 Ti, from about 0.08 to about 0.025 wt. % Zr.

FIG. 6 depicts a multi-alloy monolithic extrusion configured to provide a rib or bulkhead 20 having attachment flanges 21a, 21b composed of an alloy to provide attachment points with improved crack growth properties. In one embodiment, the attachment flanges 21 may be provided by an aluminum alloy having high toughness and fatigue resistance, such as Aluminum Association 2XXX, and the core 22 of the is provided by an aluminum alloy having high strength, such as an Aluminum Association 7XXX aluminum alloy. In one embodiment, each of the opposing attachment flanges 21a, 21b may be of a different alloy. In another example, multi-alloy monolithic extrusion bulkhead or rib 20 may be composed of aluminum alloys from the same Aluminum Association series, whereas core portions 22 requiring high strength would have a higher degree of precipitate hardening constituents than the attachment flanges 21 requiring fatigue and toughness performance, as well as resistance to cracking.

FIG. 7 depicts a rocker arm 30 formed as a multi-alloy monolithic extrusion in which the fulcrum 31 and the portions of the rocker arm 30 contacting the lifter, or other mechanism for actuating rocker arm 30 movement and valve actuation, are composed of an alloy providing high durability, fatigue and toughness performance and the core 32 of the rocker arm body is composed of a high strength alloy, such as Aluminum Association 7XXX or 6XXX series alloy. In another example, multi-alloy monolithic extrusion rocker arm may be composed of aluminum alloys from the same Aluminum Association series, whereas portions requiring high strength would have a higher degree of precipitate hardening constituents than the portions requiring fatigue and toughness performance, as well as resistance to cracking.

FIG. 8 depicts the fuselage frame 40 formed as a multi-alloy monolithic extrusion having a first portion 41 composed of a high strength alloy, such as an alloy selected from Aluminum Association 7XXX series alloys, and a second portion 42 composed of an alloy having greater fatigue performance than the first portion 1, such as an alloy selected from Aluminum Association 2XXX series alloys. In another example, the multi-alloy monolithic extrusion fuselage frame 40 may be composed of aluminum alloys from the same Aluminum Association series, wherein the portions requiring high strength would have a higher degree of precipitate hardening constituents than the portions requiring fatigue and toughness performance, as well as resistance to cracking.

FIG. 9 depicts the high strength stiffener 50 having a skin portion 51 composed of an alloy having high fatigue and toughness performance, such as an alloy selected from Aluminum Association 2XXX series alloys. The skin portion 51 may be stiffened with reinforcing members 52 composed of a high strength alloy, such as an alloy selected from Aluminum Association 7XXX series alloys.

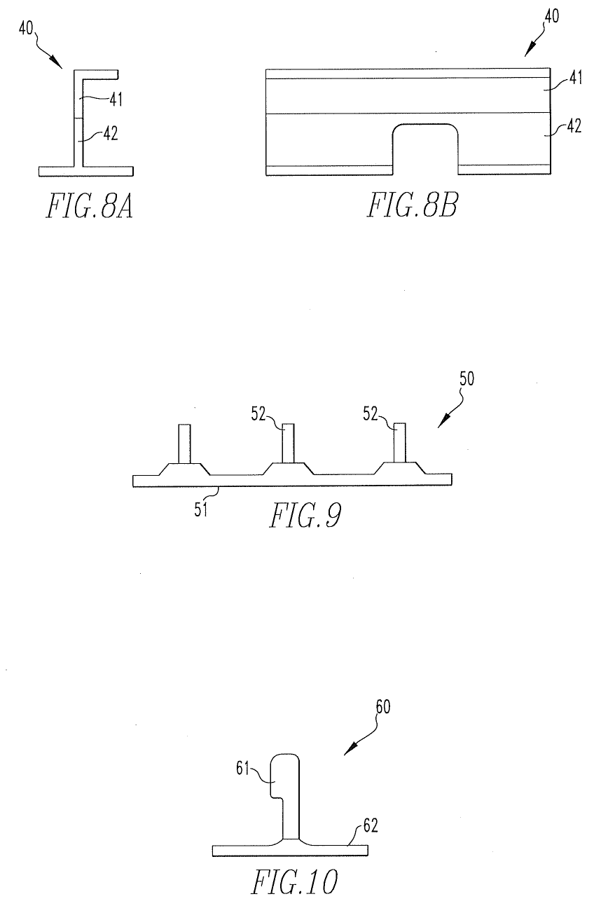

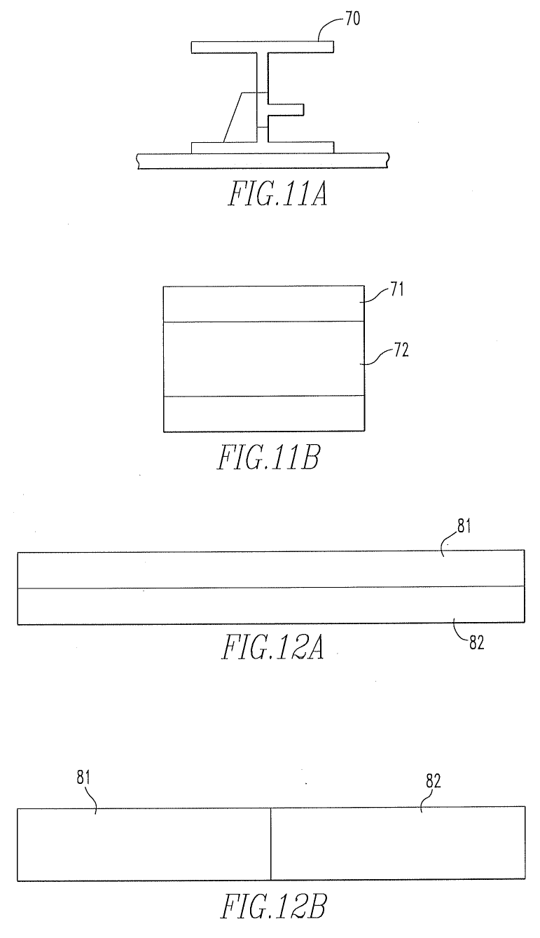

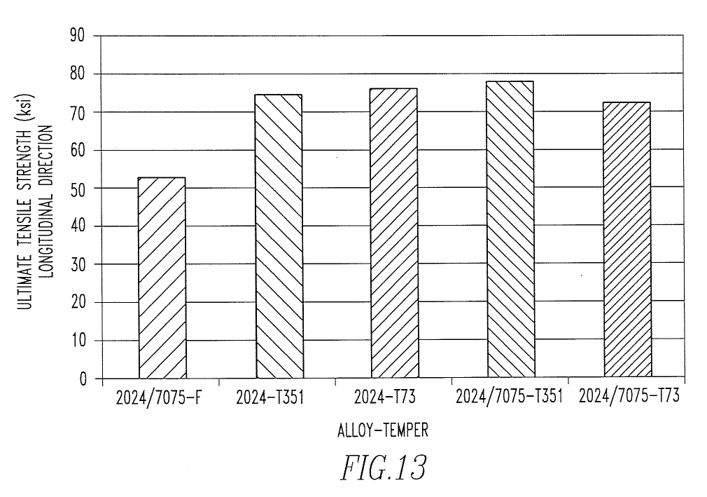

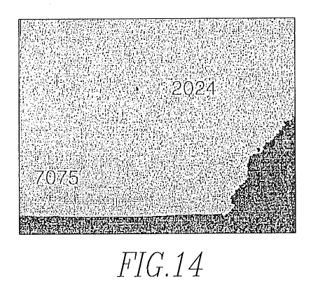

FIG. 10 depicts a stringer 60 formed from a multi-alloy monolithic extrusion, in accordance with the present invention. In one embodiment, the body 61 of the stringer is composed of a high strength aluminum alloy, such as Aluminum Association 7XXX, and includes a flange 62 composed of an alloy having greater fatigue resistance performance than the body of the stringer, such as Aluminum Association 2XXX.

FIGS. 11a and 11b depict a multi-alloy monolithic extrusion having an integral crack stopper 70. In one embodiment, an alloy composition providing crack resistance, such as Aluminum Association 2XXX series alloy, is positioned between alloy compositions providing increased strength, such as Aluminum Association 7XXX. It is noted that the above description is not limited to 2XXX, 6XXX or 7XXX alloys, as other alloys have been contemplated, and are within the scope of the present invention.

In another aspect of the present invention, a method is provided for manufacturing the above described multi-alloy monolithic extrusion. Although, the following description, discusses a bi-alloy extrusion, wherein the monolithic extrusion is composed of two alloys, the following disclosure is equally applicable to extrusions of three, four, five or greater than five alloys, so long as each billet is sectioned and machined to contact one another and joined to allow for each of the alloys to be co-extruded together.

First, the method calls for providing a first billet, which is manufactured from a first aluminum alloy, and at least a second billet, which is manufactured from a second aluminum alloy. Each of the billets have a first end, a second end, and an exterior surface. The billets are then sectioned, preferably along the billets longitudinal direction (L), in order to expose an interior surface. Preferably, the surfaces to be joined as machined substantially flat. In one embodiment, each of the first and second billets are cut in half to form half billets. The half billet formed from the first billet is hereafter referred to as the first half billet. The half billet formed from the second billet is hereafter referred to as the second half billet.

Once the first half billet is properly positioned adjacent to the second half billet, as depicted in FIG. 12a, the first half billet is welded to the second half billet to form a third billet. Although tack welding (e.g. gas metal arc welding, gas tungsten arc welding, friction stir welding) is preferred, it is noted that one skilled in the art would recognize that other welding techniques such as high density welding (laser, electron beam), pressure/cold welding, brazing, adhesive bonding, mechanical joint cold, mechanical joint forged, weld splicing along face, and weld splicing along billet may also be used to weld the two billet halves to one another.

The third billet is then extruded through an extrusion die thereby forming the desired multi-alloy monolithic extrusion. In other words, the first and second half billets are co-extruded through the extrusion die, which metallurgically fuses the aluminum alloy used in the first half billet to the aluminum alloy used in the second half billet. The temperature of the extrusion process is selected to provide softening of the alloys in providing the metallurgical fusion bonding the alloy compositions of the multi-alloy monolithic extrusion.

In one embodiment of the disclosed method, the interior surface of the first half billet as well as the interior surface of the second half billet are flat machined prior to positioning the first half billet adjacent to the second half billet in order to ensure that the interior surface of each billet half is substantially flat. After the interior surface of each of the billet halves have been flat machined, the interior surface of the first half billet is positioned adjacent to and in contact with the interior surface of the second half billet prior to welding. In one embodiment, a clean interior surface on the sectioned billets is provided by encasing the billets and reducing moisture content through the use of desiccant.

In another embodiment, a first billet and at least a second billet are sectioned perpendicular to the longitudinally direction, wherein each billet is positioned adjacent to one another at their sectioned ends, as depicted in FIG. 12b. It is noted that one skilled in the art would recognize that the first and second half billets could be stacked vertically, placed side-by-side in a horizontal manner, or consist of strategically placed vertical and horizontal mixtures.

Although the invention has been described generally above, the following examples are provided to further illustrate the present invention and demonstrate some advantages that arise therefrom. It is not intended that the invention be limited to the specific examples disclosed.

### EXAMPLES

FIG. 13 depicts the ultimate tensile strength of a multi-alloy monolithic extrusion (co-extrusion) composed of Aluminum Association 2024 and 7075 and comparative examples of extrusions of Aluminum Association 2024 and extrusions of Aluminum Association 7075. As can be seen in FIG. 13, the aluminum alloy extrusions were subjected to a variety of aging processes following co-extrusion. For example, the comparative example extrusion of Aluminum Association 2024 was aged to a T351 temper, the comparative example extrusion of Aluminum Association 7075 was aged to a T73 temper, and the multi-alloy monolithic extrusion (co-extrusion) composed of Aluminum Association 2024 and 7075 were aged to either a T351 or a T73 temper. The ultimate tensile strength of the multi-alloy monolithic extrusion (co-extrusion) composed of Aluminum Association 2024 and 7075 in the F temper was also recorded.

The multi-alloy monolithic extrusion (co-extrusion) composed of Aluminum Association 2024 and 7075 was prepared by providing one 2024 aluminum alloy billet and one 7075 aluminum alloy billet. Each of the billets were cut in half and the interior surface flat machined prior to stacking one billet half on top of the other. Once stacked, the billets were inspected to ensure that the side of each billet were adjacent to and in line with the corresponding side of the other billet. After the positioning of the billets was verified, the billet halves were tack welded at each corner (four corners) to ensure that the billets would be securely fastened to one another during the extruding process. It is noted that one skilled in the art would recognize that other methods of welding the two billets together may be utilized without departing from the teachings of this invention. The welds were belt sanded to smooth each corner and the welded billet was then extruded.

All of the aluminum alloys in FIG. 13 were extruded using the following extrusion parameters. The press container was set at about 750 degrees Fahrenheit and the tools and billets were heated to about 780 degrees Fahrenheit. The extrusion ratio was 32:6, the ram speed was set at 4 ipm (inches per minute), and the product speed was 10.9 fpm (feet per minute). To achieve the T351 temper, the aluminum alloys were solution heat treated from about 905° F. to about 915° F. for about 30 minutes, quenched at about room temperature, then stretched by about 2%. To achieve the T73 temper, the aluminum alloys were solution heat treated from about 905° F. to about 915° F. for about 15 minutes, quenched at about room temperature, aged for about 10 hours with a temperature ranging from about 244° F. to about 255° F., then aged for an additional 8 hours at about 335° F. to about 345° F.

As can be seen in FIG. 13, the comparative example extrusion of 2024-T351 aluminum alloy had an ultimate tensile strength of 74.9 ksi. The comparative example extrusion of Aluminum Association 7075-T73 aluminum alloy had an ultimate tensile strength of 76.2 ksi. The multi-alloy monolithic extrusion (co-extrusion) composed of Aluminum Association 2024 and 7075 and heat treated to T351 temper exhibited an ultimate tensile strength of 77.8 ksi, which was a 4% increase in ultimate tensile strength in the longitudinal direction when compared to the comparative example extrusion of Aluminum Association 2024-T351 aluminum alloy and a 2% increase in ultimate tensile strength in the longitudinal direction when compared to the comparative example extrusion of Aluminum Association 7075-T73 aluminum alloy. FIG. 13 also shows that the multi-alloy monolithic extrusion (co-extrusion) composed of Aluminum Association 2024 and 7075 in F-temper had an ultimate tensile strength of 53.4 ksi and the multi-alloy monolithic extrusion (co-extrusion) composed of Aluminum Association 2024 and 7075 and heat treated T73 temper had an ultimate tensile strength of 72.3 ksi.

The multi-alloy monolithic extrusion (co-extrusion) composed of Aluminum Association 2024 and 7075 and heat treated T73 temper was also tested for micro-hardness, in which an ingot was sectioned to allow for micro-hardness values to be measured from the 2024 alloy portions of the multi-alloy monolithic extrusion across the interface and into the 7075 alloy portions of the multi-alloy monolithic extrusion. The micro-hardness was measured in accordance with ASTM standard E92, which is the Standard Test Method for Vickers Hardness of Metallic Materials. The micro-hardness data for a 2024/7075 multi-alloy monolithic extrusions were aged to T73 temper is depicted in FIG. 2, which depicts a plot of microhardness (HV) as a function of location across the extrusion (mm). The interface between the 2024 alloy portion and 7075 alloy portion is indicated by reference number 100. The transition from the 2024 alloy portion to the 7075 alloy portion represents a gradual change in mechanical properties in response to an applied stress, which is typically observed in articles having a unitary structure being free of intermetallic interfaces. The micro-hardness measurements are consistent with a metallic fusion of the 2024 alloy and 7075 alloy at the alloy interface, as taught by the present invention. FIG. 14 depicts a micrograph of a failure observed in one embodiment of a 2024/7075 multi-alloy monolithic extrusions aged to T73 temper. The failure occurred in the weaker Aluminum Association 2024 alloy, as compared to the higher strength 7075 alloy, and not the interface positioned between the 7075 and 2024 alloys, hence further illustrating the metallic fushion between the two alloys and the characterization of the multi-alloy monolithic extrusion acting as a unitary structure, having the performance of a single, rigid, uniform whole.

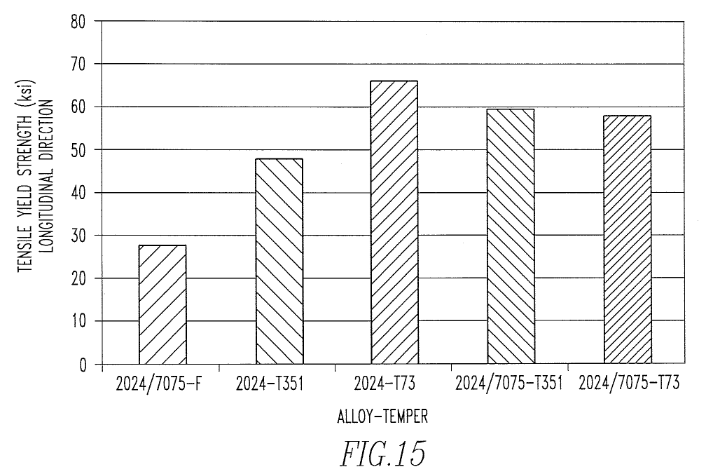

FIG. 15 depicts the tensile yield strength of a multi-alloy monolithic extrusion (co-extrusion) composed of Aluminum Association 2024 and 7075 in comparison to single alloy extrusions of Aluminum Association 2024 and 7075. As can be seen in FIG. 15, the aluminum alloy extrusions were subjected to a variety of aging processes following extrusion. For example, the 2024 extrusion was aged to a T351 temper, the 7075 extrusion was aged to a T73 temper, and the 2024/7075 multi-alloy monolithic extrusions were aged to either a T351 or T73 temper. The tensile yield strength of the 2024/7075 multi-alloy monolithic extrusion in the F temper was also recorded.

The 2024/7075 multi-alloy monolithic extrusions were prepared by providing one 2024 aluminum alloy billet and one 7075 aluminum alloy billet. Each of the billets were cut in half and the interior surface flat machined prior to stacking one billet half on top of the other. Once stacked, the billets were inspected to ensure that the corners of each billet were adjacent to and in line with the corresponding corner of the other billet. After the positioning of the billets were verified, the billet halves were tack welded at each corner (four corners) to ensure that the billets would be securely fastened to one another during the extruding process. The welds were belt sanded to smooth each corner and the welded billet was then extruded.

All of the aluminum alloys in FIG. 15 were extruded in the following manner. The press container was set at about 750 degrees Fahrenheit and the tools and billets were heated to about 780 degrees Fahrenheit. The extrusion ratio was 32:6, the ram speed was set at 4 ipm (inches per minute), and the product speed was 10.9 fpm (feet per minute). To reach the T351 temper, the aluminum alloys were solution heat treated from about 905° F. to about 915° F. for about 30 minutes, quenched at about room temperature, then stretched by about 2%. To reach the T73 temper, the aluminum alloys were solution heat treated from about 905° F. to about 915° F. for about 15 minutes, quenched at about room temperature, aged for about 10 hours with a temperature range ranging from about 244° F. to about 255° F., then aged for an additional 8 hours at about 335° F. to about 345° F.

As can be seen in FIG. 15, the 2024-T351 aluminum alloy had a tensile yield strength of 48.6 ksi. The 7075-T73 aluminum alloy had a tensile yield strength of 66.9 ksi. The 2024/7075-T351 multi-alloy monolithic extrusions had a tensile yield strength of 59.7 ksi, which is a 19% increase in tensile yield strength in the longitudinal direction when compared to the 2024-T351 aluminum alloy. FIG. 15 also shows that the 2024/7075-F temper multi-alloy monolithic extrusions had a tensile yield strength of 28.1 ksi and the 2024/7075-T73 temper multi-alloy monolithic extrusions had a tensile yield strength of 58.2 ksi.

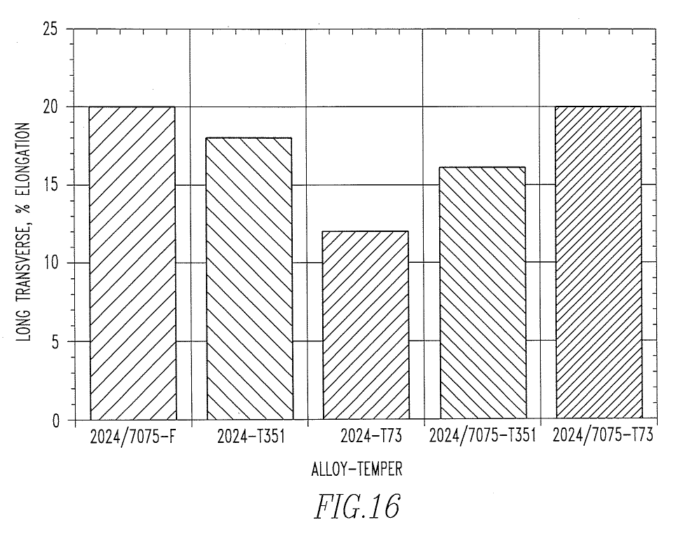

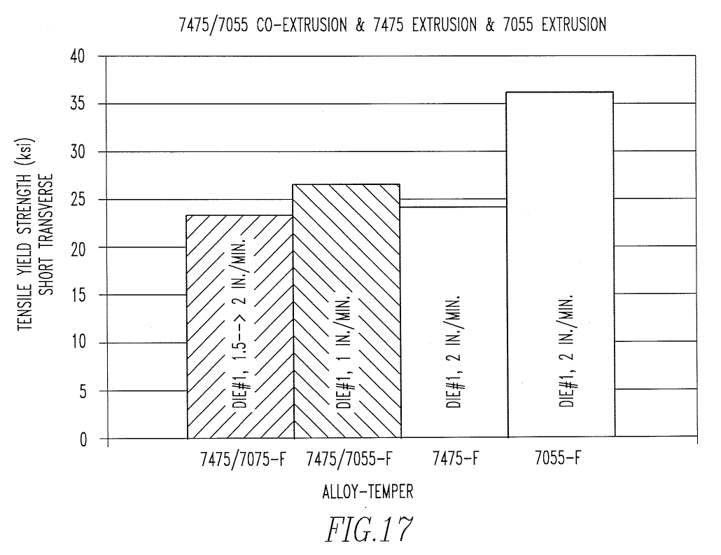

FIG. 16 depicts the percent elongation of 2024/7075 multi-alloy monolithic extrusions and comparative examples of single alloy extrusions of Aluminum Association 2024 and 7075. As can be seen in FIG. 16, the aluminum alloy extrusions were subjected to a variety of aging processes following extrusion. For example, the 2024 extrusion was aged to a T351 temper, the 7075 extrusion was aged to a T73 temper, and the 2024/7075 co-extrusions were aged to either a T351 or T73 temper. The percent elongation of the 2024/7075 co-extrusion in the F temper was also recorded.

The 2024/7075 multi-alloy monolithic extrusions were prepared by providing one 2024 aluminum alloy billet and one 7075 aluminum alloy billet. Each of the billets were cut in half and the interior surface flat machined prior to stacking one billet half on top of the other. Once stacked, the billets were inspected to ensure that the corners of each billet were adjacent to and in line with the corresponding corner of the other billet. After the positioning of the billets were verified, the billet halves were tack welded at each corner (four corners) to ensure that the billets would be securely fastened to one another during the extruding process. The welds were belt sanded to smooth each corner and the welded billet was then extruded.

All of the aluminum alloys in FIG. 16 were extruded in the following manner. The press container was set at about 750 degrees Fahrenheit and the tools and billets were heated to about 780 degrees Fahrenheit. The extrusion ratio was 32:6, the ram speed was set at 4 ipm (inches per minutes), and the product speed was 10.9 fpm (feet per minute).

As can be seen in FIG. 16, the comparative extrusion of 2024-T351 aluminum alloy had a long transverse elongation of 18%. The comparative extrusion of 7075-T73 aluminum alloy had a long transverse elongation of 12%. The 2024/7075-T351 multi-alloy monolithic extrusion had a long transverse elongation of 16%, which was a 25% increase in elongation when compared to the 7075-T73 aluminum alloy. FIG. 16 also shows that the 2024/7075-F multi-alloy monolithic extrusions had a long transverse elongation of 20% and the 2024/7075-T73 multi-alloy monolithic extrusions had a long transverse elongation of 20%, which was a 40% increase in elongation when compared to the comparative extrusion of 7075-T73 aluminum alloy and a 10% increase in elongation when compared to the comparative extrusion of 2024-T351 aluminum alloy.

FIG. 17 depicts the tensile yield strength of 7475/7055 multi-alloy monolithic extrusions, and comparative examples of single alloy extrusions of Aluminum Association 7475, and 7075 aluminum alloy. As can be seen in FIG. 17, all of the aluminum alloy extrusions were F tempers. The 7475/7055 multi-alloy monolithic extrusions were prepared by providing one 7475 aluminum alloy billet and one 7055 aluminum alloy billet. Each of the billets were machined in half and inspected to ensure that the machined surfaces (i.e. interior surface of each billet) were smooth and had a 32 micro inch machine finish. Prior to stacking one billet half on top of the other billet half, the machined surface of each billet was wiped with a solvent wipe (e.g. acetone) to ensure a clean surface. The billet halves were then stacked, welded, and extruded through the extrusion die.

All of the aluminum alloys in FIG. 17 were extruded in the following manner. The press container was set at about 850 degrees Fahrenheit and the tools and billets were heated to a temperature range ranging from about 688 degrees Fahrenheit to about 735 degrees Fahrenheit. The extrusion ratio was 20:1 and the ram speed was set between 2.54 cm/minute (1 inch/minute) to 5.08 cm/minute (2 inches/minute).

As can be seen in FIG. 17, the tensile yield strength of the 7475/7055-F multi-alloy monolithic extrusions was 23.3 ksi in the short transverse direction when the ram speed was set between 3.81 cm/minute (1.5 inches/minute) to 5.08 cm/minute (2 inches/minute) and 26.7 ksi when the ram speed was set at 2.54 cm/minute (1 inch/minute). When the ram speed was set at 5.08 cm/minute (2 inches/minute), the tensile yield strength of the 7475-F aluminum alloy extrusion was 24.5 ksi in the short transverse direction and the tensile yield strength of the 7055-F alloy extrusion was 36.7 ksi. FIG. 17 shows an 8% increase in tensile yield strength when the 7475/7055-F multi-alloy monolithic extrusions was extruded with a ram speed of 2.54 cm/minute (1 inch/minute) is compared to the 7475-F aluminum alloy that was extruded with a ram speed of 5.08 cm/minute (2 inches/minute).

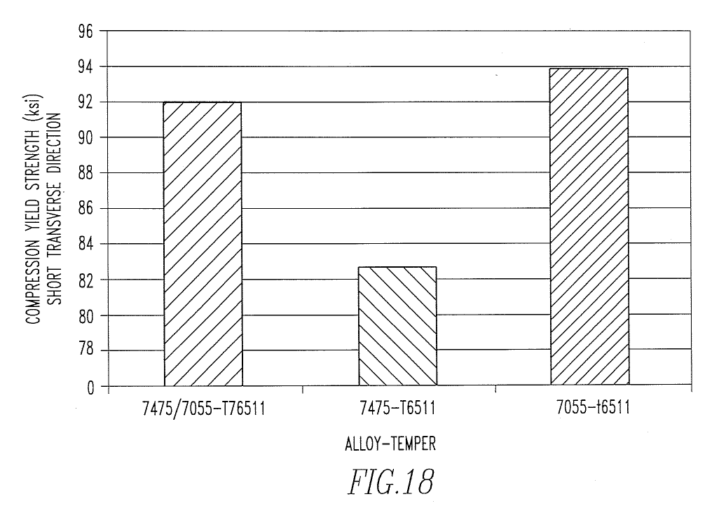

FIG. 18 depicts the tensile yield strength of aluminum alloy 7475, 7075, and the 7475/7075 multi-alloy monolithic extrusions. As can be seen in FIG. 18, the 7475/7055 multi-alloy monolithic extrusion was aged to a T76511 temper. The 7475 and 7055 aluminum alloys were aged to a T76511 temper. The 7475/7075-T6511 multi-alloy monolithic extrusion was prepared by providing one 7475 aluminum alloy billet and one 7075 aluminum alloy billet. Each of the billets were machined in half and inspected to ensure that the machined surfaces were smooth and had a 32 micro inch machine finish. Prior to stacking one billet half on top of the other billet half, the machined surface of each billet was wiped with a solvent wipe (e.g. acetone) to ensure a clean surface. The billet halves were then stacked, welded, and extruded through the extrusion die.

All of the aluminum alloys in FIG. 18 were extruded in the following manner. The press container was set at about 850 degrees Fahrenheit and the tools and billets were heated to a temperature range ranging from about 688 degrees Fahrenheit to about 735 degrees Fahrenheit. The extrusion ratio was 30:1 and the ram speed was set at 3.81 cm/minute (1.5 inches/minute).

As can be seen in FIG. 18, the compression yield strength of the 7475/7055-T76511 multi-alloy monolithic extrusions was 92.1 ksi. The 7475-T76511 alloy had a tensile yield strength of 82.8 ksi and the 7055-T76511 aluminum alloy had a tensile yield strength of 93.9 ksi. FIG. 18 shows that the 7475/7055-T6511 multi-alloy monolithic extrusions had a 10% increase in compression yield strength when compared to the 7475-T6511 aluminum alloy and had an almost identical yield strength when compared to the 7475-T76511 aluminum alloy.

Multi-alloy monolithic extrusions composed of aluminum lithium alloys, Aluminum Association 2099 and 2199, were prepared and heat treated to T8 temper. Comparative examples of single alloy extrusions of Aluminum Association 2199 and 2099 were also prepared and heat treated to T-8 temper. The 2099/2199 multi-alloy monolithic extrusions were extruded in the following manner. The press container was set at about 760 degrees Fahrenheit and the tools and billets were heated to about 790 degrees Fahrenheit. The extrusion ratio was 32:6, the ram speed was set at about 4 ipm (inches per minute), and the product speed was greater than about 9.0 fpm (feet per minute). To reach T8 temper, the billets were at an oven temperature set to 850° f. for 17 hours, followed by a solution heat treatment at a temperature on the order of about 1000° F., quenched at about room temperature, then stretched by about 3%, and aged at a temperature of about 300° F. for approximately 36 hours.

The mechanical properties of the 2099/2199 multi-alloy monolithic extrusions were measured to have a tensile yield strength (long transverse) of about 59 Ksi, an ultimate tensile strength of about 68 Ksi, and an elongation of about 13%. The comparative example of Aluminum Association 2199 had a tensile yield strength (long transverse) of about 67 Ksi, an ultimate tensile strength of about 76 Ksi, and an elongation of about 13%. The comparative example of Aluminum Association 2099 had a tensile yield strength (long transverse) of about 58 Ksi, an ultimate tensile strength of about 66 Ksi, and an elongation of about 15%.

It was observed that the interface of the aluminum lithium billets had to be controlled to ensure that moisture was minimized at the interface of the two alloys. Excess moisture disadvantageously resulted in oxidation at the interface. To reduce moisture content and the formation of oxide at the interface, a clean interior surface on the sectioned billets may be provided by encasing the billets and reducing moisture content through the use of desiccant prior to loading in the extrusion container.

Having described the presently preferred embodiments, it is to be understood that the invention may be otherwise embodied within the scope of the appended claims.

What is claimed is:

1. A structural member comprising:
a multi-alloy monolithic extrusion comprising a first aluminum alloy and a second aluminum alloy; and said first aluminum alloy metallurgically fused to said second aluminum alloy.

2. The structural member of claim 1, wherein at least one of the first aluminum alloy and the second aluminum alloy is a heat treatable aluminum alloy.

3. The structural member of claim 1, wherein at least one of the first aluminum alloy and the second aluminum alloy is not a heat treatable aluminum alloy.

4. The structural member of claim 1, wherein at least one of the first aluminum alloy and the second aluminum alloy is an aluminum-lithium alloy.

5. The structural member of claim 1, wherein said first aluminum alloy is selected from the Aluminum Association's 2XXX, 6XXX or 7XXX series of aluminum alloys.

6. The structural member of claim 1, wherein at least one of the first aluminum alloy and the second aluminum alloy comprises Aluminum Association's 2XXX, 6XXX or 7XXX series of aluminum alloys.

7. The structural member of claim 6, wherein at least one of said first aluminum alloy and said second aluminum alloy comprises Aluminum Association 7×50, 7×85, 7×75, 7×55, 2×24, or 2×26.

8. The structural member of claim 1, wherein said first aluminum alloy is 7075 and said second aluminum alloy is 2024.

9. The structural member of claim 1, wherein said first aluminum alloy is 7475 and said second aluminum alloy is 7055.

10. The structural member of claim 1, wherein the monolithic multi-alloy extrusion is an aircraft structural member.

11. The structural member of claim 10, wherein the aircraft structural member comprises an aircraft engine beam, a landing gear beam, a wing spar, a horizontal stabilizer spar, a fuselage stringer, a top center wing box, or a machined rib.

12. The structural member of claim 1, wherein the multi-alloy monolithic extrusion is a vehicular structural member.

13. The structural member of claim 12, wherein the vehicular structural member comprises is a component of an automobile, motorcycle, bicycle, scooter, truck, bus, ship, submarine, tractor, or train.

14. An extrusion method comprising:
providing a first billet and at least a second billet;
machining the first billet to form a first substantially flat surface;
machining the second billet to form a second flat surface;
positioning the first flat surface of the first billet adjacent to the second flat surface of the second billet;
welding at least a portion of the first billet to the second billet to form a third billet; and
extruding the third billet to form a monolithic multi-alloy structural member.

15. The extrusion method of claim 14, further comprising:
providing at least one other billet;
machining the at least one other billet to form at least one other flat surface; and
joining the at least one other flat surface of the at least one other billet to an exposed surface of the first or the second billet prior to the extruding to form the monolithic multi-alloy structural member.

16. The extrusion method of claim 14, wherein at least one of the first billet or the second billet comprises a aluminum-lithium alloy.

17. The extrusion method of claim 14, wherein at least one of the first billet and the second billet comprises Aluminum Association's 2XXX, 6XXX or 7XXX series of aluminum alloys.

18. The extrusion method of claim 14, wherein the welding of the first billet to the second billet comprises gas metal arc welding, gas tungsten arc welding, or friction stir welding.

19. The extrusion method of claim 14 further comprising grinding welded portions of the third billet prior to the extrusion of the third billet.

20. The extrusion method of claim 14 further comprising heat treating the multi-alloy monolithic structural member.
